(19) United States
(12) Patent Application Publication
(10) Pub. No.: US 2025/0252805 A1
(43) Pub. Date: Aug. 7, 2025

(54) MOUNTING BRACKET ASSEMBLY FOR DEVICE

(71) Applicant: ADP, Inc., Roseland, NJ (US)

(72) Inventors: Eric Vicknair, Atlanta, GA (US); Harrison Vicknair, Atlanta, GA (US)

(73) Assignee: ADP, Inc., Roseland, NJ (US)

(21) Appl. No.: 18/434,570

(22) Filed: Feb. 6, 2024

(51) Int. Cl. G07F 9/10

(52) U.S. Cl. CPC G07F 9/10

(57) ABSTRACT

A mounting bracket assembly includes a mounting frame and a faceplate. The mounting frame includes a mounting frame first side, a mounting frame second side, a mounting frame third side, and a mounting frame fourth side. The mounting frame also includes a face surface extending along the mounting frame second side and the mounting frame fourth side, a plurality of mounting channels, and a first receiving channel located on the face surface, the first receiving channel extending along a first axis. The mounting frame includes a second receiving channel extending along a second axis parallel the first axis, the second receiving channel located on the face surface. The faceplate includes a faceplate base, a first guide channel extending along the first axis configured to be coupled to the first receiving channel, and a second guide channel extending along the second axis configured to be coupled to the second receiving channel.

### TECHNICAL FIELD

The present disclosure relates generally to a mounting bracket assembly for a device. More specifically, the present disclosure relates to arrangements for providing a modular kiosk for a device using a mounting bracket assembly.

### BACKGROUND

A kiosk terminal (or computer kiosk or interactive kiosk or kiosk) houses a device, such as a computer, and provides goods or services to a user. For example, in workforce management, a kiosk terminal may be used to record relevant workforce and product information. However, the kiosk terminal may be expensive and difficult to install. Moreover, the angle of the kiosk terminal cannot be modified to accommodate the specific needs of an application without removing and installing a completely new kiosk terminal. For example, each kiosk terminal may only be suitable for certain applications (e.g., vertical wall mounting, horizontal surface mounting, etc.).

### SUMMARY

In one embodiment, a mounting bracket assembly includes a mounting frame and a faceplate. The mounting frame includes a mounting frame first side, a mounting frame second side, a mounting frame third side, a mounting frame fourth side, a face surface, a plurality of mounting channels, a first receiving channel, and a second receiving channel. The mounting frame second side is contiguous with the mounting frame first side, the mounting frame third side is contiguous with the mounting frame second side, and the mounting frame fourth side is contiguous with the mounting frame third side and the mounting frame first side. The face surface extends along the mounting frame second side and the mounting frame fourth side, and the plurality of mounting channels extend along the mounting frame. The plurality of mounting channels includes a first mounting channel, a second mounting channel, a third mounting channel, and a fourth mounting channel. The first receiving channel is located on the face surface extending along a first axis and the second receiving channel is located on the face surface extending along a second axis parallel the first axis. The faceplate includes a faceplate base, a first guide channel extending along the first axis, and a second guide second guide channel extending along the second axis. The first guide channel is configured to be coupled to the first receiving channel and the second guide channel configured to be coupled to the second receiving channel.

In another embodiment, the mounting bracket assembly includes a mounting frame and a faceplate removably coupled to the mounting frame. The mounting frame includes a mounting frame first side, a mounting frame second side, a mounting frame third side, a mounting frame fourth side, a plurality of mounting channels, an alignment groove, a first receiving channel, a second receiving channel, a first cut-out, and a second cut-out. The mounting frame second side is contiguous with the mounting frame first side, the mounting frame third side is contiguous with the mounting frame second side, and the mounting frame fourth side is contiguous with the mounting frame third side and the mounting frame first side. The plurality of mounting channels extends along the mounting frame. The mounting channels include a first mounting channel, a second mounting channel, a third mounting channel, and a fourth mounting channel. The alignment groove extends along the mounting frame first side and is located between the first mounting channel and the second mounting channel. The first receiving channel is located on the mounting frame second side extending along a first axis, and the second receiving channel is located on the mounting frame fourth side extending along a second axis parallel the first axis. The first cut-out is located on the mounting frame second side, and the second cut-out is located on the mounting frame fourth side. The faceplate includes a faceplate base, a security tab, a first guide channel extending along the first axis, and a second guide channel extending along the second axis. The first guide channel is configured to be coupled to the first receiving channel and the second guide channel is configured to be coupled to the second receiving channel. The security tab extends away from the faceplate base in the same direction as the first guide channel and the second guide channel and the security tab is configured to be coupled to an outer side of the mounting frame first side.

In yet another embodiment, the mounting bracket assembly includes a mounting frame and a faceplate. The mounting frame includes a mounting frame first side, a mounting frame second side, a mounting frame third side, a mounting frame fourth side, a plurality of mounting channels, an alignment groove, a first receiving channel, a second receiving channel, and a plurality of knockout holes. The mounting frame second side is contiguous with the mounting frame first side, the mounting frame third side is contiguous with the mounting frame second side, and the mounting frame fourth side contiguous with the mounting frame third side and the mounting frame first side. The plurality of mounting channels extends along the mounting frame. The plurality of mounting channels includes a first mounting channel, a second mounting channel, a third mounting channel, and a fourth mounting channel. The alignment groove extends along the mounting frame first side, and the alignment groove is located between the first mounting channel and the second mounting channel. The first receiving channel is located on the mounting frame second side extending along a first axis, and the second receiving channel is located on the mounting frame fourth side extending along a second axis parallel the first axis. The plurality of knockout holes is located on the mounting frame third side, and the plurality of knockout holes are located on either side of the alignment groove. The faceplate includes a faceplate base, a first guide channel extending along the first axis, and a second guide channel extending along the second axis. The first guide channel is configured to be coupled to the first receiving channel and the second guide channel is configured to be coupled to the second receiving channel.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a perspective view of an example mounting bracket assembly;

FIG. 2 is a front view of the mounting bracket assembly shown in FIG. 1;

FIG. 3 is a back view of the mounting bracket assembly shown in FIG. 1;

FIG. 4 is a top view of the mounting bracket assembly shown in FIG. 1;

FIG. 5 is a bottom view of the mounting bracket assembly shown in FIG. 1;

FIG. 6 is a left view of the mounting bracket assembly shown in FIG. 1;

FIG. 7 is a right view of the mounting bracket assembly shown in FIG. 1;

FIG. 8 is a perspective view of an example mounting frame for a mounting bracket assembly;

FIG. 9 is a perspective view of another example mounting frame for a mounting bracket assembly;

FIG. 10 is a perspective view of an example faceplate for a mounting bracket assembly;

FIG. 11 is another perspective view of the faceplate shown in FIG. 10;

FIG. 12 is a perspective view of another example faceplate for a mounting bracket assembly;

FIG. 13 is another perspective view of the faceplate shown in FIG. 12;

FIG. 14 is another perspective view of the faceplate shown in FIG. 12;

FIG. 15 is a flowchart illustrating an example embodiment of the installation process for a mounting bracket assembly;

FIG. 16 is a flowchart illustrating an example embodiment of the replacement process for a mounting bracket assembly;

FIG. 17 is a perspective view of an example mounting bracket assembly;

FIG. 18 is a front view of the mounting bracket assembly shown in FIG. 17;

FIG. 19 is a back view of the mounting bracket assembly shown in FIG. 17;

FIG. 20 is a top view of the mounting bracket assembly shown in FIG. 17;

FIG. 21 is a bottom view of the mounting bracket assembly shown in FIG. 17;

FIG. 22 is a left view of the mounting bracket assembly shown in FIG. 17; and

FIG. 23 is a right view of the mounting bracket assembly shown in FIG. 17.

It will be recognized that the Figures are the schematic representations for purposes of illustration. The Figures are provided for the purpose of illustrating one or more implementations with the explicit understanding that the Figures will not be used to limit the scope of the meaning of the claims.

### DETAILED DESCRIPTION

Following below are more detailed descriptions of various concepts related to, and implementations of, methods, apparatuses, and for providing a mounting bracket assembly for a device. The various concepts introduced above and discussed in greater detail below may be implemented in any of a number of ways, as the described concepts are not limited to any particular manner of implementation. Examples of specific implementations and applications are provided primarily for illustrative purposes.

It is important to capture accurate and precise data in several scenarios. For example, at workplaces, capturing workforce production data is critical. Such data can include amount of time worked, shift times, attendance, and other such workforce related information. In several workplaces, a device, such as a modular kiosk, is used to record workforce data. After the device is used a certain amount of time, the device is serviced or replaced. Additionally, it may be occasionally desired to angle the device, such as to facilitate users with different physical abilities to access the device. When the device is coupled to a vertical, horizontal, or otherwise angled surface using a mounting bracket, removing, servicing, and replacing the mounting bracket may be difficult and time intensive because the entire mounting bracket must be removed. One approach to angling the device is to provide a single-unit angled wall mount. However, this does not solve the time intensive issue of needing to replace the entire mounting bracket. This one-piece mounting bracket approach also does not allow for the angle to quickly be altered to best accommodate an operator, nor does the one-piece mounting bracket approach allow for the mounting bracket to be suitable for multiple applications (e.g., moving a vertical mounted mounting bracket to a horizontal surface, etc.).

Implementations described herein are related to a device with a mounting bracket assembly, including a mounting frame and interchangeable faceplates. The interchangeable faceplates include guide channels configured to slide onto receiving channels located on the mounting frame. In this way, devices utilizing the mounting bracket assembly described herein are more desirable than other one-piece mounting brackets that cannot be rapidly installed, serviced, replaced, and repurposed (e.g., by changing a faceplate of the mounting bracket). The mounting bracket assembly may also be more desirable due to security features, reduced racking, and other features to aid in making the installation process easier and faster.

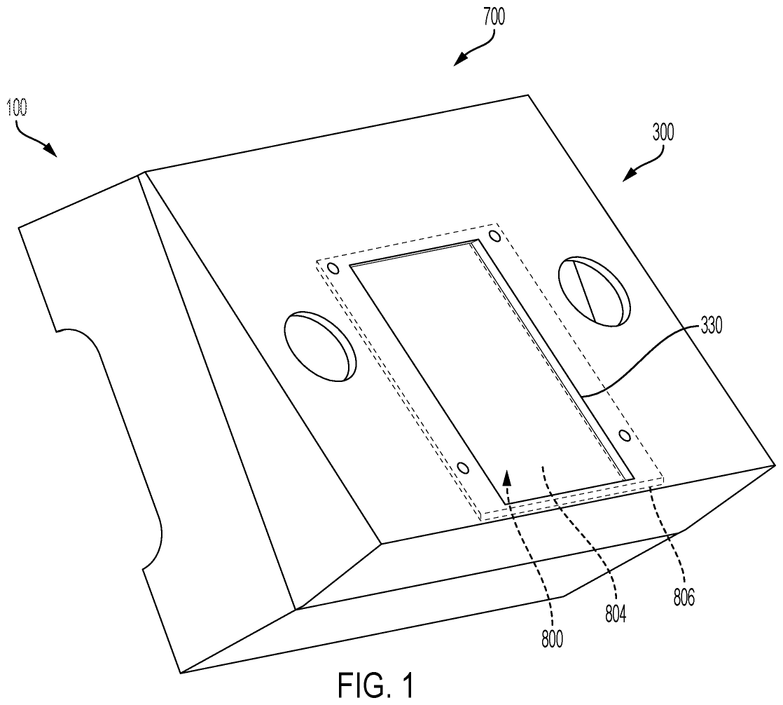

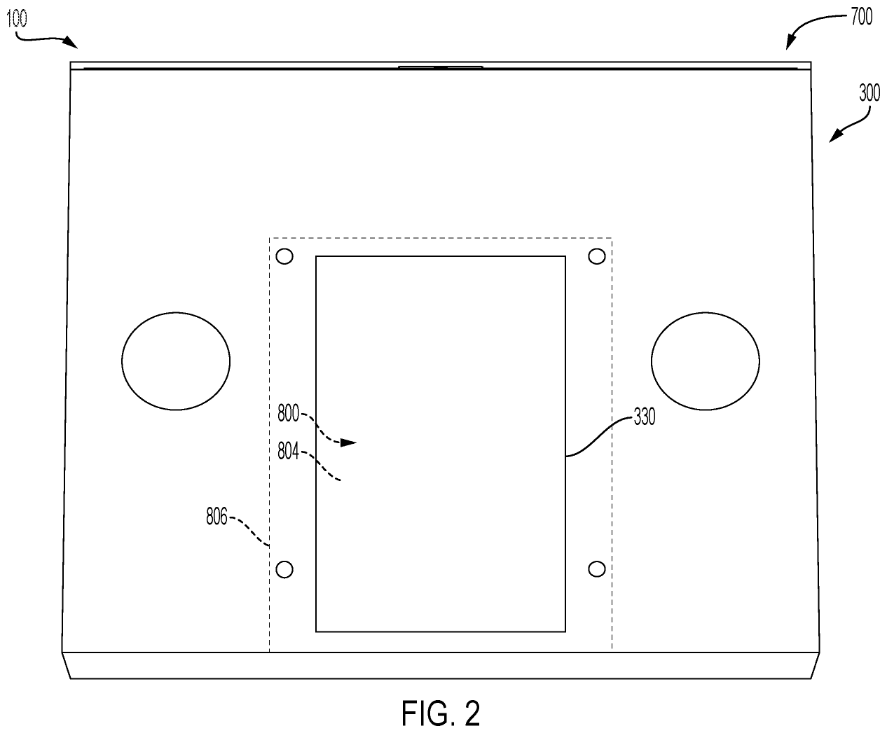

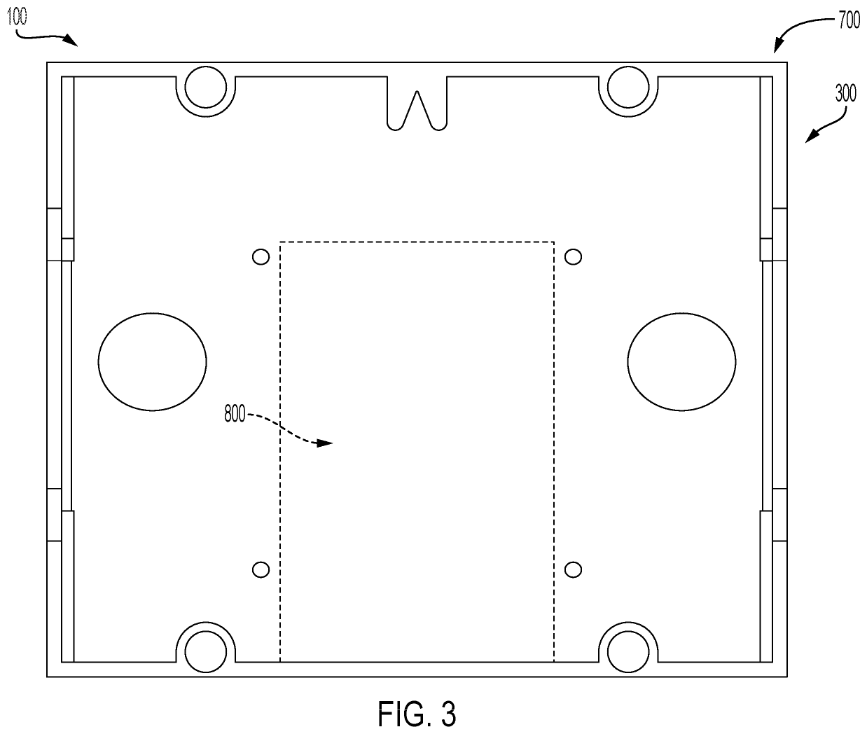

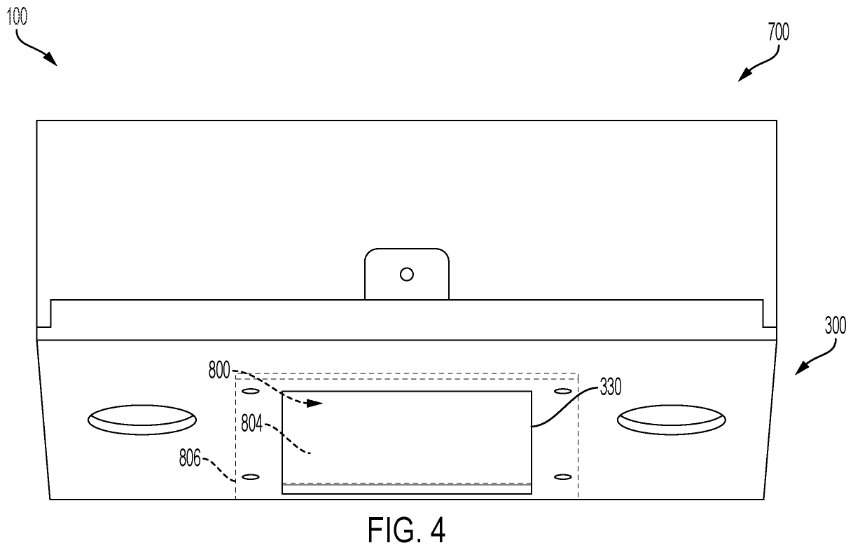

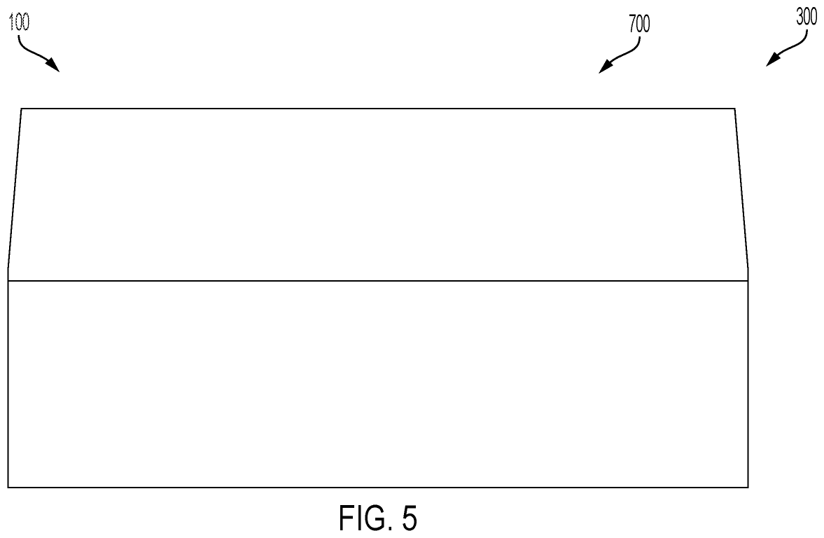

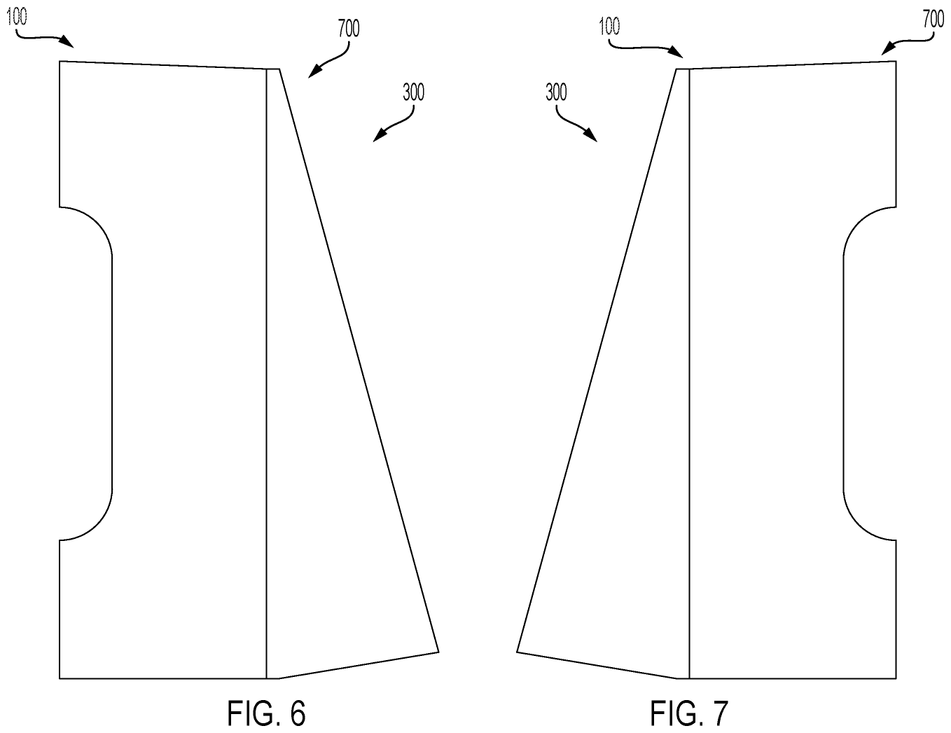

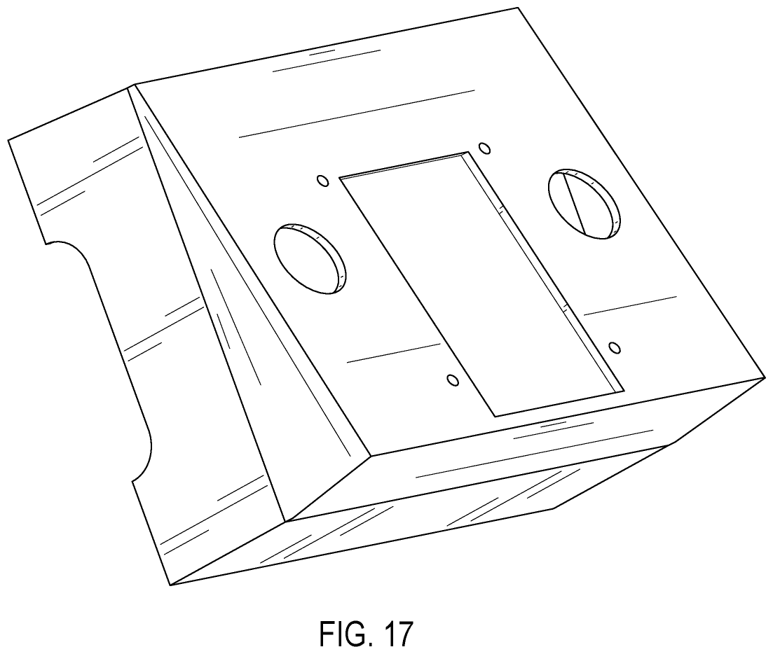

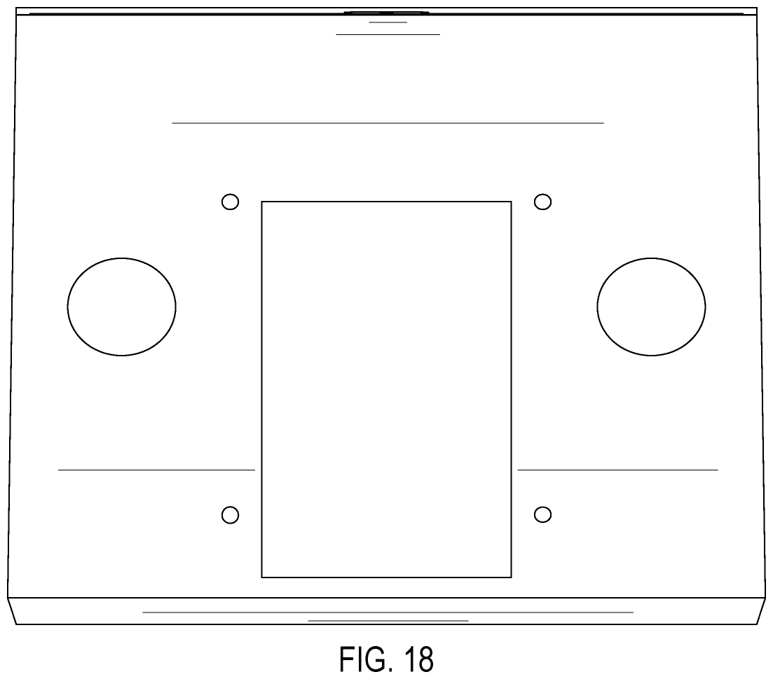

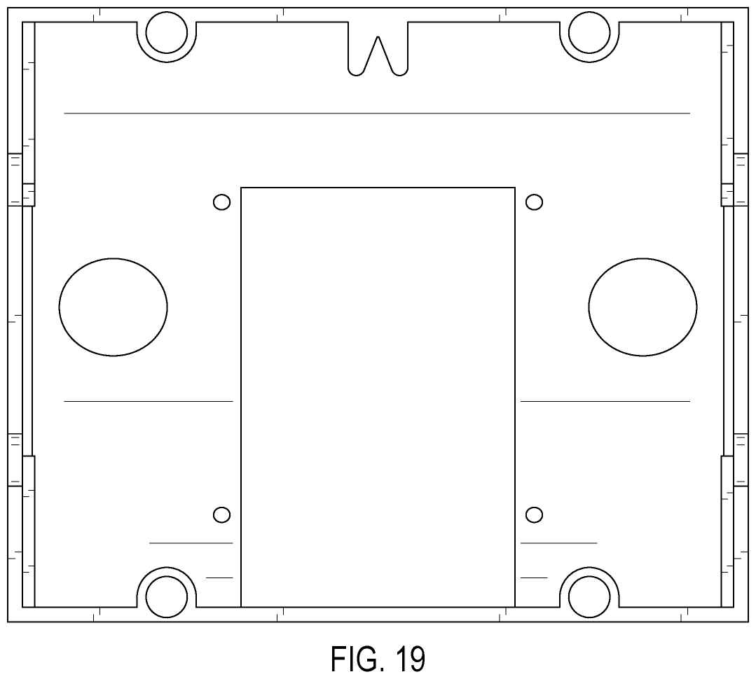

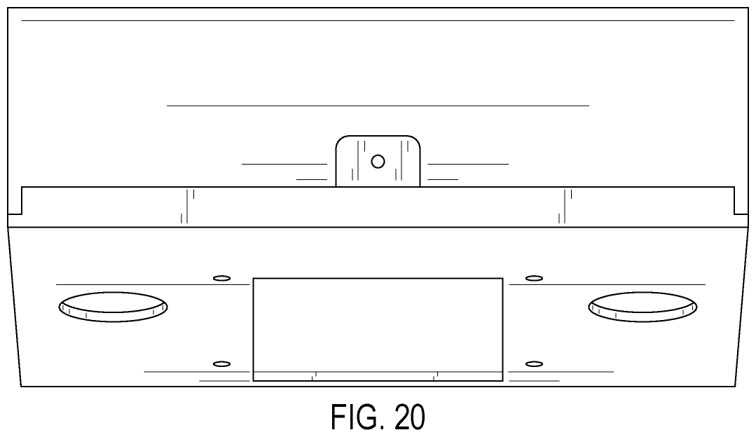

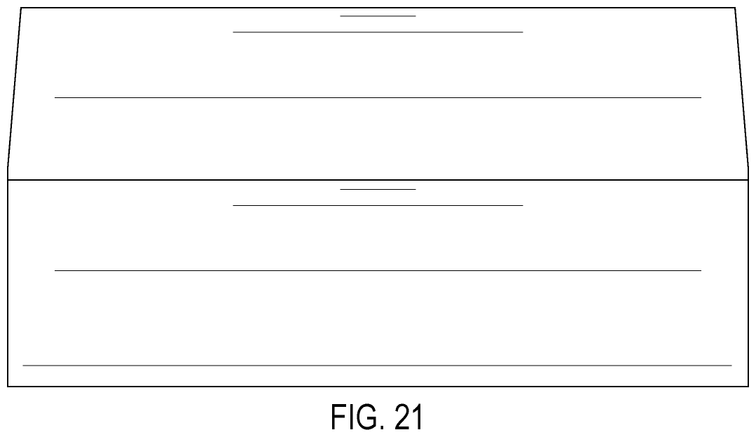

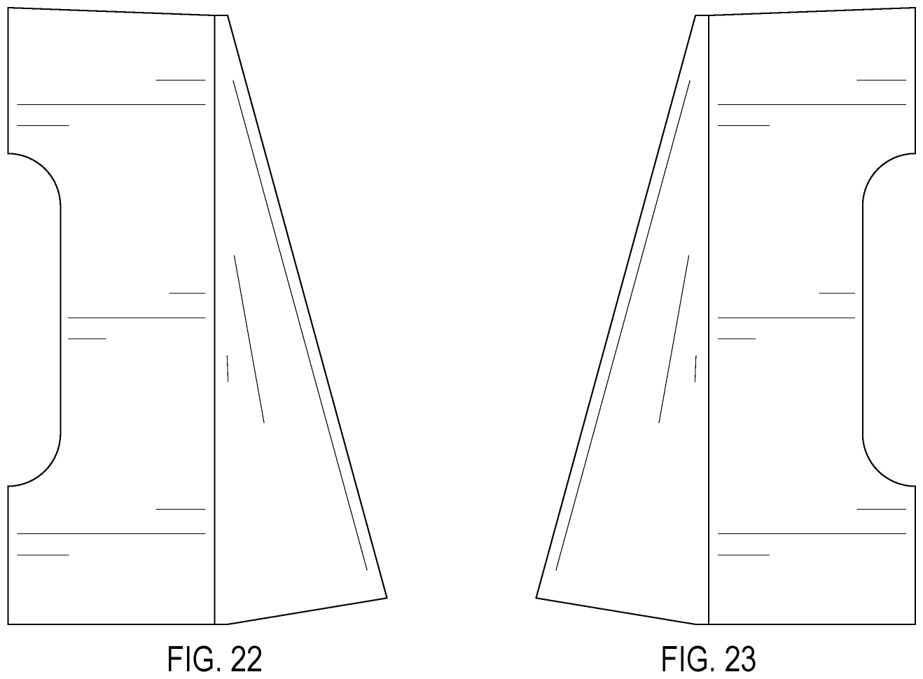

FIGS. 1-7 and 17-23 show a mounting bracket assembly 700 (e.g., support fabrication, mounting bracket construction, etc.). The mounting bracket assembly 700 is utilized to hold a device 800 (e.g., tablet, phone, computer, etc.) up against a surface. The surface may be vertical, horizontal, or otherwise angled. The mounting bracket assembly 700 includes a faceplate 300 (e.g., cover, front plate, display attachment, etc.) and a mounting frame 100 (e.g., mounting body, mounting structure, framing body, etc.). The faceplate 300 functions to hold the device 800 relative to the mounting frame 100. The faceplate 300 is interchangeable with other faceplates 300, and each of the faceplates 300 is differently configured such that the mounting bracket assembly 700 may be tailored for a target application (e.g., use with a target surface, use with a target device 800, etc.) by selecting a target faceplate 300. In this way, the mounting bracket assembly 700 is more desirable than other mounting systems which are not capable of being tailored to a target surface and device.

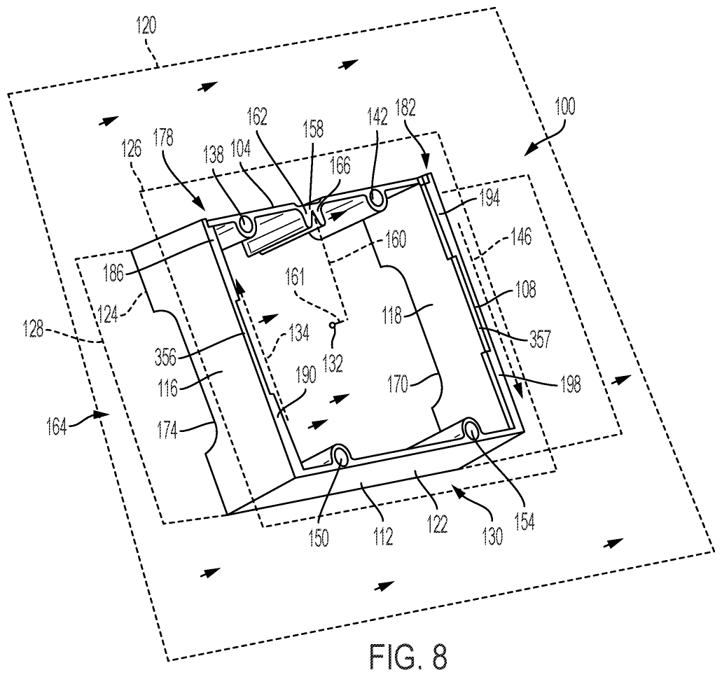

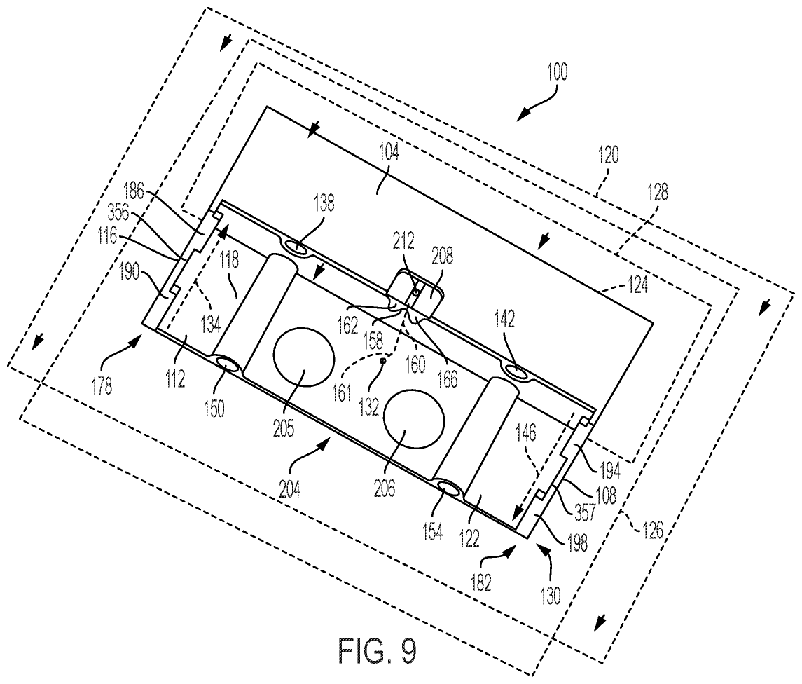

FIGS. 8-9 depict the mounting frame 100 according to various embodiments. The mounting frame 100 is shown as being disposed along a first plane 120. The mounting frame 100 includes a mounting frame first side 104 (e.g., area, segment, face, etc.), a mounting frame second side 108 (e.g., area, segment, face, etc.), a mounting frame third side 112 (e.g., area, segment, face, etc.), and a mounting frame fourth side 116 (e.g., area, segment, face, etc.). The mounting frame second side 108 (e.g., area, segment, face, etc.) is contiguous with the mounting frame first side 104. The mounting frame third side 112 (e.g., area, segment, face, etc.) is contiguous with the mounting frame second side 108. The mounting frame fourth side 116 (e.g., area, segment, face, etc.) is contiguous with the mounting frame third side 112 and the mounting frame first side 104. The mounting frame 100 may include more or fewer mounting sides to create a target shape (e.g., polygon shape, parallelogram shape, etc.) for the device 800 or a location where the mounting frame 100 is installed.

The mounting frame 100 includes a wall surface 124 (e.g., vertical plane, border surface, etc.) disposed along a second plane 128 (e.g., flat, etc.). The wall surface 124 of the mounting frame 100 is the portion of the mounting frame 100 intended to be approximately flush to a wall or other vertical surface. Since the wall surface 124 is disposed along a second plane 128, the wall surface 124 is also planer. The mounting frame 100 also includes a face surface 126 (e.g., front plane, exterior surface, etc.). The face surface 126 extends along the mounting frame second side 108 and the mounting frame fourth side 116. The face surface 126 is configured to be coupled (e.g., attached, fixed, welded, fastened, riveted, adhesively attached, bonded, pinned, etc.) to the faceplate 300.

The mounting frame 100 includes a plurality of mounting channels 130 (e.g., affixing guides, installing routes, mounting conduits, etc.) extending along the mounting frame 100 located on an inner side 118 (e.g., central location, interior side, etc.) of the mounting frame 100. The mounting channels 130 includes a first mounting channel 138 (e.g., guide, route, conduit, etc.) and a second mounting channel 142 (e.g., guide, route, conduit, etc.), each of which is disposed along the mounting frame first side 104. The mounting channels 130 also include a third mounting channel 150 (e.g., guide, route, conduit, etc.) and a fourth mounting channel 154 (e.g., guide, route, conduit, etc.), each of which is disposed along the mounting frame third side 112. The first mounting channel 138 and the second mounting channel 142 extend continuously from the wall surface 124 towards the face surface 126. The mounting channels 130 do not extend far enough to overlap with the face surface 126, instead there is a distance between the mounting channels 130 and the face surface 126 equivalent to a width of a faceplate base 304. The third mounting channel 150 and the fourth mounting channel 154 extend continuously from the wall surface 124 to the face surface 126. The distance allows the faceplate 300 to slide onto the mounting frame 100 from the mounting frame first side 104 to the mounting frame third side 112. In other embodiments the mounting channels 130 are not continuous and start and end anywhere between the wall surface 124 and the face surface 126. That is, the mounting channels 130 each include multiple portions and gaps.

The mounting frame 100 also includes an alignment groove 158 (e.g., orienting channel, positioning ridge, arrangement groove, etc.). In various embodiments, the alignment groove 158 extends along the mounting frame first side 104 from the wall surface 124 towards the face surface 126 and is located between the first mounting channel 138 and the second mounting channel 142. The alignment groove 158 does not extend far enough to overlap with the face surface 126, instead there the distance between the mounting channels 130 and the face surface 126 is equivalent to the width of the faceplate base 304. The alignment groove 158 includes a first prong 162 (e.g., tine, arc, point, rib, projection, etc.) and a second prong 166 (e.g., tine, arc, point, rib, projection, etc.) configured to straddle a fastener (e.g., nail, screw, pin, etc.).

The alignment groove 158 is centered on an alignment axis 160. The alignment groove 158 is configured such that the alignment axis 160 is parallel to the first plane 120. A reference line 161 intersects and is orthogonal to the first plane 120 and extends through both the alignment axis 160 and a center of gravity 132 of the mounting frame 100. The alignment groove 158 is centered on the center of gravity 132 so that the mounting frame 100 can be centered and leveled during installation without the usage of additional measuring or leveling equipment. In some embodiments, the alignment groove 158 is not continuous (i.e., the alignment groove 158 includes multiple portions). In other embodiments, the alignment groove 158 starts and ends anywhere between the wall surface 124 and the face surface 126 (i.e., the alignment groove 158 does not extend along an entire length of the mounting frame first side 104).

The mounting frame 100 also includes a security tab recess 208 (e.g., security indentation, protection depression, etc.) and a security screw hole 212 (e.g., mounting hole, etc.). The security tab recess 208 is located on an outer side 122 (e.g., exterior side, outer surface, etc.) of the mounting frame first side 104 that is opposite a portion of the alignment groove 158. The security tab recess 208 is configured to receive a security tab 313 to prevent removal of the faceplate 300 from the mounting frame 100. Therefore, the security tab recess 208 and security tab 313 combination help to deter and prevent theft of the device 800 or any other portion of the mounting bracket assembly 700. The security screw hole 212 is located at a center of the security tab recess 208 and extends through the mounting frame first side 104. In other embodiments, the mounting frame 100 does not contain the security tab recess 208 or the security screw hole 212. The security tab recess 208 and the security screw hole 212 may be located on any portion of any side of the mounting frame 100 that is configured to be coupled to the security tab 313.

The mounting frame 100 also includes a first receiving channel 178 (e.g., accepting path, collection route, receiving passage, etc.). The first receiving channel 178 extends along a first axis 134 (e.g., way, path, etc.). The first receiving channel 178 is located along the face surface 126 of the mounting frame fourth side 116. The first receiving channel 178 includes a first receiving channel first portion 186 (e.g., segment, piece, etc.), a first receiving channel second portion 190 (e.g., segment, piece, etc.), and a first slot 356. The first slot 356 (e.g., opening, gap, etc.) is configured between the first receiving channel first portion 186 and the first receiving channel second portion 190. The first slot 356 is continuous with at least one of the first receiving channel first portion 186 or the first receiving channel second portion 190. In some embodiments, the first receiving channel 178 has more than two portions. In some embodiments, the first receiving channel 178 is continuous, and includes only one portion and does not include the first slot 356. In some embodiments, the first receiving channel 178 includes more than one of the first slot 356. In some embodiments, the first receiving channel 178 extends along a portion of the mounting frame fourth side 116.

The mounting frame 100 also includes a second receiving channel 182 (e.g., accepting path, collection route, receiving passage, etc.). The second receiving channel 182 extends along a second axis 146 (e.g., way, path, etc.) opposite the first axis 134. The first axis 134 is parallel to the second axis 146. The second receiving channel 182 is located along the face surface 126 of the mounting frame first side 104. The second receiving channel 182 includes a second receiving channel first portion 194, a second receiving channel second portion 198, and a second slot 357. The second slot 357 is configured between the second receiving channel first portion 194 and the second receiving channel second portion 198. The second slot 357 is continuous with at least one of the second receiving channel first portion 194 or the second receiving channel second portion 198. In some embodiments, the second receiving channel 182 has more than two portions and more than one of the second slot 357. In some embodiments, and the second receiving channel 182 is continuous, and includes only one portion and does not contain the second slot 357. In some embodiments, the second receiving channel 182 extends along only a portion of the mounting frame first side 104.

The mounting frame 100 also includes a plurality of knockout holes 204 (e.g., punch-out voids, removable cavities, etc.), as in FIG. 9. The knockout holes 204 include a first knockout hole 205 (e.g., punch-out void, removable cavity, etc.) and a second knockout hole 206 (e.g., punch-out void, removable cavity, etc.). The knockout holes 204 are located on the mounting frame third side 112 between the third mounting channel 150 and the fourth mounting channel 154. The first knockout hole 205 and the second knockout hole 206 are located on either side of the alignment groove 158. The knockout holes 204 are pre-molded and can be punched out for an insertion of electrical conduits. In an example embodiment, the knockout holes 204 are all 25.4 millimeters (mm) (1 inch) diameter circles. In some embodiments, the knockout holes 204 are all different diameters. In some embodiments, there are more than two of the knockout holes 204, while in others there is only one or no knockout holes 204. In other embodiments, the knockout holes 204 can be located on the mounting frame first side 104, the mounting frame second side 108, or the mounting frame fourth side 116. In other embodiments, the knockout holes 204 are not located between the third mounting channel 150 and the fourth mounting channel 154, and instead are located between the third mounting channel 150 and the mounting frame fourth side 116 and between the fourth mounting channel 154 and the mounting frame second side 108. In other embodiments, the knockout holes 204 are not located on either side of the alignment groove 158. Instead, the knockout holes 204 are located directly across from the alignment groove 158.

In some embodiments, the mounting frame 100 include cut-outs 164 (e.g., holes, side grooves, etc.). The cut-outs 164 include a first cut-out 170 (e.g., hole, side groove, etc.) and a second cut-out 174 (e.g., hole, side groove, etc.). The first cut-out 170 is located on the mounting frame second side 108 and the second cut-out 174 is located on the mounting frame fourth side 116. Each of the cut-outs 164 creates an empty arc-shaped space in the mounting frame 100 along the wall surface 124. This space can be used to run cables through, such as power or CAT-5 ethernet cables, without the need for drilling or cutting the mounting frame 100. The cut-outs 164 allow passthrough of any of the cables from the device 800 out of the mounting bracket assembly 700 while reducing weight and materials for construction. In some embodiments, there is only one of the cut-outs 164 and in other embodiments there are more than two of the cut-outs 164. In some embodiments, the cut-outs 164 are not located against the wall surface 124 and are instead located between the wall surface 124 and the face surface 126 (e.g., located midway between the wall surface 124 and the face surface 126, etc.). In other embodiments, the cut-outs 164 are not arc-shaped, and instead are another shape (e.g., polygon shape, parallelogram shape, etc.).

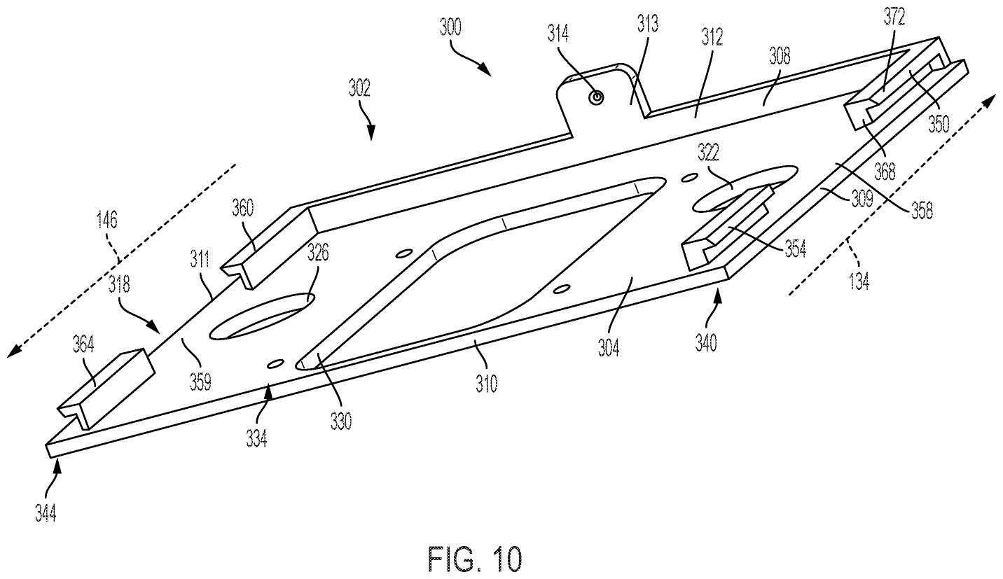

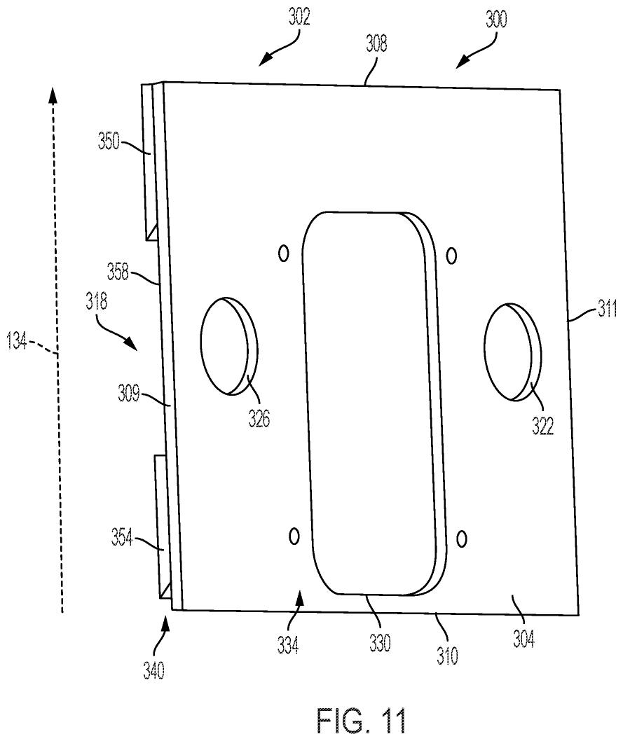

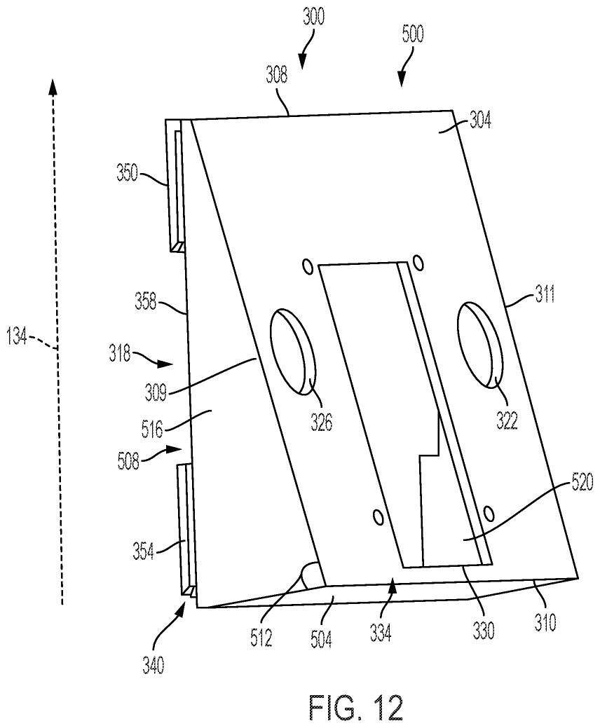

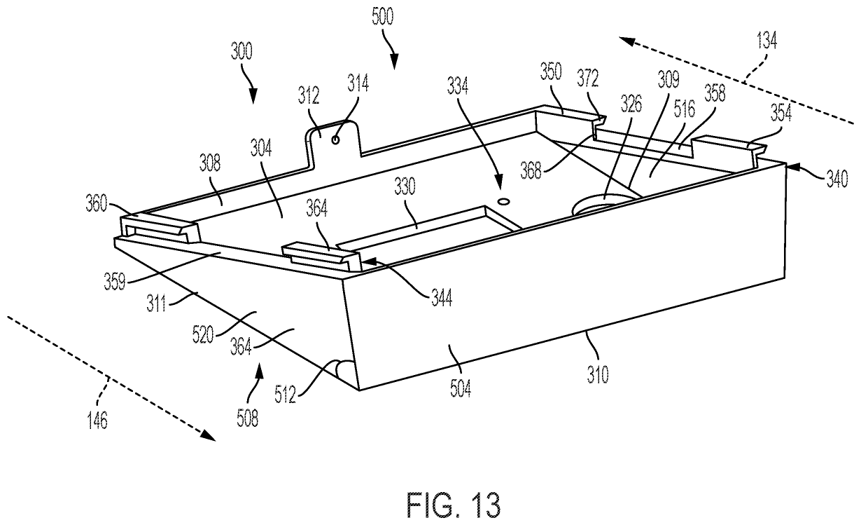

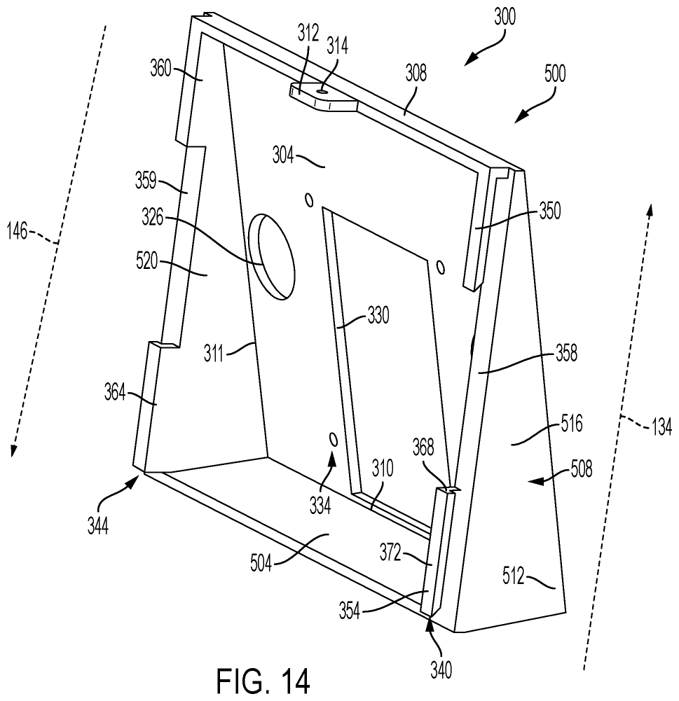

FIGS. 10-14 depict various embodiments of the faceplate 300. The faceplate 300 includes the faceplate base 304 (e.g., faceplate bottom, attachment base, etc.), a faceplate ledge 312 (e.g., ledge, etc.) a first side of the faceplate 308, a second side of the faceplate 309, a third side of the faceplate 310, and a fourth side of the faceplate 311. The first side of the faceplate 308, the second side of the faceplate 309, the third side of the faceplate 310, and the fourth side of the faceplate 311 extend from the faceplate base 304. The first side of the faceplate 308 is parallel to the third side of the faceplate 310, and the second side of the faceplate 309 is parallel to the fourth side of the faceplate 311. The faceplate ledge 312 extends from the first side of the faceplate 308 away from the faceplate base 304 and is perpendicular to the faceplate base 304.

The faceplate base 304 also includes the security tab 313 (e.g., security stub, etc.) that extends from a portion of the faceplate ledge 312 away from the faceplate base 304. The security tab 313 extends in the same direction as the first guide channel 340 and the second guide channel 344. The security tab 313 is located equidistance between the first guide channel 340 and the second guide channel 344. In some embodiments (i.e., when there is not the security tab recess 208), the security tab 313 is configured to be coupled to the outer side 122 of the mounting frame first side 104. In some embodiments, the faceplate ledge 312 and the security tab 313 extend from the second side of the faceplate 309, the third side of the faceplate 310, or the fourth side of the faceplate 311. In some embodiments, the security tab 313 extends directly from the first side of the faceplate 308, the second side of the faceplate 309, the third side of the faceplate 310, or the fourth side of the faceplate 311 without the faceplate ledge 312. In some embodiments, the faceplate ledge 312 extends at a non-perpendicular angle from the first side of the faceplate 308. In some embodiments, the security tab 313 extends at a non-perpendicular angle from the first side of the faceplate 308, the second side of the faceplate 309, the third side of the faceplate 310, or the fourth side of the faceplate 311.

The security tab 313 is rectangularly shaped with curved corners and includes a security tab hole 314 located approximately centered on the security tab 313 to enable the installation of a security screw. In some embodiments, the security tab 313 is non-rectangular (e.g., oval shaped, square shaped, parallelogram shaped, trapezoidal shaped, etc.) and does not have curved corners. In some embodiments, the security tab 313 does not exist or there is more than one of the security tabs 313 extending from the faceplate base 304. In some embodiments, there is more than one of the security tab hole 314 or the security tab hole 314 does not exist.

The faceplate base 304 includes a display screen hole 330 (e.g., presentation display hole, etc.) centered approximately in the middle of the faceplate base 304. The display screen hole 330 allows for passthrough of the cables from the device 800 into the mounting frame 100 while reducing the weight and materials for construction. The device 800, which includes a device screen 804, is mounted behind the display screen hole 330. The display screen hole 330 is shaped rectangularly with curved corners. In other embodiments, the display screen hole 330 is at a different predetermined location, and not centered on the faceplate base 304. In other embodiments, the display screen hole 330 is not shaped rectangularly or does not have curved corners and is a different shape (e.g., polygon shape, parallelogram shape, etc.) to better suit displaying the device screen 804 or running the appropriate cables through the display screen hole 330. In other embodiments, the display screen hole 330 is smaller than the device screen 804 and enables the user to access or view only a portion of the device screen 804. In some embodiments the display screen hole 330 allows the user to access or see the device 800 that is installed in the mounting bracket assembly 700. In some embodiments, the device 800 is mounted in or in front of the display screen hole 330. In other embodiments, the device 800 is not mounted in, in front, or behind the display screen hole 330.

The faceplate base 304 includes faceplate holes 318 (e.g., gripping holes, etc.). The faceplate holes 318 include a first faceplate hole 322 and a second faceplate hole 326 of equal circular diameter located equidistant from the display screen hole 330 on either side of the display screen hole 330. The faceplate holes 318 allow the user to reach inside the mounting bracket assembly 700 and behind the device 800 while it is mounted inside the mounting bracket assembly 700 (i.e., to power the device 800 on or off, to change the volume settings, to unplug the device 800, etc.). The faceplate holes 318 also facilitate easier installation and removal of the faceplate 300 by providing the user with a spot to grip the faceplate base 304. In some embodiments, the faceplate 300 does not include faceplate holes 318, or includes only one of the faceplate holes 318. In some embodiments, the faceplate 300 includes more than two of the faceplate holes 318. In some embodiments, the faceplate holes 318 are located at different distances from the display screen hole 330. In some embodiments the diameters of the faceplate holes 318 are different. In some embodiments the faceplate holes 318 are not circular (e.g., polygon shape, parallelogram shape, etc.). In some embodiments the faceplate holes are 12.7 mm (e.g., 0.5 in)-50.8 mm (e.g., 2 in) in diameter.

The faceplate 300 includes display screen mounting holes 334. The display screen mounting holes 334 are located around the display screen hole 330 and are spaced to facilitate the installation of the screen 806. The display screen mounting holes 334 accommodate a standardized Video Electronics Standards Association (VESA) 75 mm mounting hole pattern. In some embodiments there are four of the display screen mounting holes 334. In various embodiments, the screen 806 is coupled to the faceplate 300. In other embodiments, the device 800 is coupled to the faceplate 300 (e.g., a body of the device 800 is coupled to the faceplate 300). In other embodiments, there are no display screen mounting holes 334, and the screen 806 is installed through alternative methods.

The faceplate 300 includes a first guide channel 340 (e.g., controlling conduit, directing path, etc.). The first guide channel 340 extends along the first axis 134. The first guide channel 340 extends from the second side of the faceplate 309. The first guide channel 340 includes a first ledge 368 (e.g., ridge, etc.), a second ledge 372 (e.g., ridge, etc.), a first guide channel first portion 350 (e.g., segment, piece, etc.), a first guide channel second portion 354 (e.g., segment, piece, etc.), and a third slot 358 (e.g., opening, gap, etc.). The first ledge 368 extends from the faceplate base 304 approximately perpendicularly. The second ledge 372 extends approximately perpendicularly from the first ledge 368, so the second ledge 372 is parallel to the faceplate base 304. The third slot 358 is configured between the first guide channel first portion 350 and the first guide channel second portion 354. The third slot 358 is continuous with at least one of the first guide channel first portion 350 and the first guide channel second portion 354. In some embodiments, the first guide channel 340 has more than two portions. In some embodiments, there is more than one of the third slot 358. In some embodiments, the first guide channel 340 does not have the third slot 358 and only one portion exists. In some embodiments, the first guide channel 340 extends from the first side of the faceplate 308.

The faceplate 300 includes a second guide channel 344 (e.g., controlling conduit, directing path, etc.) that extends from the fourth side of the faceplate 311 along the second axis 146. The second guide channel 344 is includes the first ledge 368 (e.g., ridge, etc.), the second ledge 372 (e.g., ridge, etc.), a second guide channel first portion 360 (e.g., segment, piece, etc.), a second guide channel second portion 364 (e.g., segment, piece, etc.), and a fourth slot 359. The fourth slot 359 is configured between the second guide channel first portion 360 and the second guide channel second portion 364. The fourth slot 359 is continuous with at least one of the second guide channel first portion 360 and the second guide channel second portion 364. In some embodiments, the second guide channel 344 has more than two portions. In some embodiments, there is more than one of the fourth slot 359. In some embodiments, the second guide channel 344 does not have the fourth slot 359 and there is only one portion. In some embodiments, the second guide channel 344 extends from the third side of the faceplate 310. In some embodiments, the first guide channel 340 or the second guide channel 344 does not exist, and the faceplate 300 and the mounting frame 100 are coupled using alternative methods.

The faceplate 300 can be interchanged with other styles of the faceplate 300 to fit user needs. For example, the user may need different mounting angles 512 (e.g., slants, etc.) to simplify and facilitate compliance with the Americans with Disabilities Act (ADA). Existing solutions for kiosk terminals can be inconvenient for people with different physical abilities (e.g., wheelchair access, different heights, missing limbs, etc.) due to the permanent mounting angles 512 of the faceplates 300 of the kiosk terminals on the market. For example, to access information from the kiosk terminal, someone that is of shorter stature may need an angled kiosk terminal. If another worker working the same position but on a different shift was not of shorter stature, they would not use an angled kiosk terminal. Since in existing solutions the faceplate 300 is an immovable part of the kiosk terminals, the entire kiosk terminal would need to be uninstalled and an angled kiosk terminal installed every shift. This is a tedious and time-consuming process to constantly install and uninstall the kiosk terminal. This interchangeable faceplate 300 design overcomes the constant need to install and uninstall an entire kiosk terminal depending on who is working in an area. The faceplate 300 can simply be slid off the mounting frame 100, and a new faceplate 300 slide on. Interchangeable faceplates allow the user to change the mounting angle 512 of the faceplate 300 without needing to drill new holes or move the location of the mounting frame 100. Two example embodiments are a flat faceplate 302 (e.g., level attachment, vertical faceplate, etc.) and a sloped faceplate 500 (e.g., inclined faceplate, slanted attachment, etc.). The flat faceplate 302 is configured to lie flat against the mounting frame 100. The sloped faceplate 500 includes an end faceplate 504 and side faceplates 508. The end faceplate 504 is contiguous with the faceplate base 304 on the third side of the faceplate 310. The side faceplates 508 include a first side faceplate 516, a second side faceplate 520 identical to the first side faceplate 516, and the mounting angles 512. The first side faceplate 516 is contiguous with the end faceplate 504 and the faceplate base 304 on the second side of the faceplate 309. The second side faceplate 520 is contiguous with the end faceplate 504 and the faceplate base 304 on the fourth side of the faceplate 311. The mounting angles 512 are angles located between the end faceplate 504 and the faceplate base 304. In the sloped faceplate 500, the first guide channel 340 extends from the first side faceplate 516 and the second guide channel 344 extends from the second side faceplate 520. In some embodiments, the mounting angles 512 are acute angles.

FIGS. 1-7 depict the mounting bracket assembly 700, which includes the faceplate 300, the mounting frame 100, the device 800, and a screen 806. The faceplate 300 is coupled to the mounting frame 100. The first receiving channel 178 is slidably engaged with the first guide channel 340. The second receiving channel 182 is slidably engaged with the second guide channel 344. The first slot 356 located in the first receiving channel 178, the second slot 357 located in the second receiving channel 182, the third slot 358 located in the first guide channel 340, and the fourth slot 359 located in the second guide channel 344 allow the faceplate 300 to slide more easily onto the mounting frame 100 with reduced racking issues, which also allows for an easier process to interchange the faceplate 300. The security tab 313 is aligned and coupled to the security tab recess 208 with a security screw. Located inside of the mounting bracket assembly 700 is the device 800. The screen 806 is coupled to the faceplate 300 by coupling the screen 806 to the display screen mounting holes 334. In other embodiments, the screen 806 does not exist. In other embodiments, the screen 806 is coupled to the faceplate 300 through alternative methods (e.g., adhesion, welding, etc.).

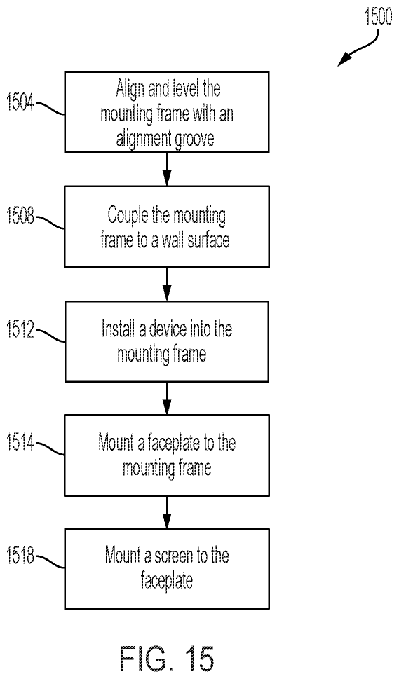

FIG. 15 illustrates an installation process 1500 (e.g., method, etc.) for installing the mounting bracket assembly 700. The installation process 1500 may be performed by, including but not limited to, the original equipment manufacturer (i.e., when the mounting bracket assembly 700 is assembled, etc.) or a service technician (e.g., a mechanic, line worker, robot, automated machine, etc.).

The installation process 1500 begins in block 1504 with aligning and leveling, by the service technician, the mounting frame 100 with the alignment groove 158. This includes securing a fastener into a vertical, horizontal, or otherwise angled surface where the mounting bracket assembly 700 is desired and hanging the mounting frame 100 on the nail by aligning the alignment groove 158 with the nail. This step will self-center and level the mounting frame 100. This step could reiterate itself until the mounting frame 100 hangs in the desired location. In some embodiments, this step includes marking on the wall or vertical surface where the mounting channels 130 touches the wall or vertical surface.

The installation process 1500 continues in block 1508 with coupling, by a service technician, the mounting frame 100 to the wall. The service technician couples the mounting frame 100 to the wall by drilling through the mounting channels 130 and into the wall. In other embodiments, there is not the mounting channels 130, and the mounting frame 100 is coupled to the wall using alternative means.

The installation process 1500 continues in block 1512 with inserting and installing, by a service technician, the device 800 into the mounting frame 100. This includes wiring the device 800 (e.g., power supply, ethernet cable, etc.) so it is usable for the device's 800 specific purpose. The wiring is either pulled through the cut-outs 164 or the knockout holes 204. In some embodiments, the knockout holes 204 are removed, by the service technician, by popping them out with a tool (e.g., screwdriver, etc.). In some embodiments an electrical conduit is inserted into the holes left by the knockout holes 204 to wire the device 800. In other embodiments, wiring that passes through the knockout holes 204 is sealed from the outside environment using another material (i.e., caulking, taping, etc.).

The installation process 1500 continues in block 1514 with coupling, by a service technician, the faceplate 300 to the mounting frame 100. This includes the service technician sliding the faceplate 300 onto the mounting frame 100 by sliding the first guide channel 340 onto the first receiving channel 178 and sliding the second guide channel 344 onto the second receiving channel 182. The service technician then attaches the security tab 313 to the security tab recess 208 by screwing a security screw into the security screw hole 212. In other embodiments, the first guide channel 340, the second guide channel 344, the first receiving channel 178, or the second receiving channel 182 do not exist. Therefore, the faceplate 300 is coupled to the mounting frame 100 through alternative means. In other embodiments, the service technician uses the faceplate holes 318 to grip the faceplate 300 to better facilitate sliding the faceplate 300 onto the mounting frame 100. In other embodiments, the security tab 313 and the security tab recess 208 are coupled using alternative means. In other embodiments, the security tab 313 does not exist, and the faceplate 300 and the mounting frame 100 are secured using alternative means (e.g., drilling through two flush sides to connect them, adhesively attach multiple sides, incorporating a security lock, etc.).

The installation process 1500 continues in block 1518 with coupling, by a service technician, the screen 806 to the faceplate 300. The service technician can screw the screen 806 to the faceplate 300 by inserting screws into the display screen mounting holes 334.

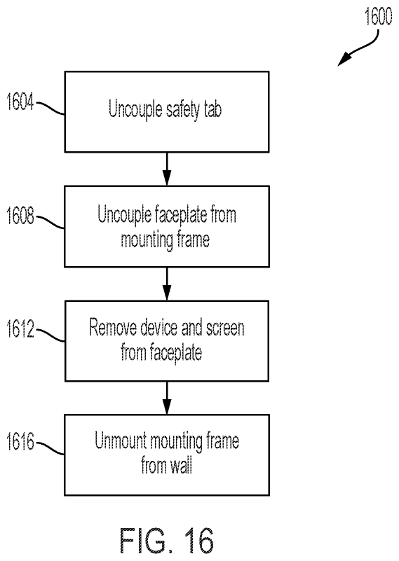

FIG. 16 illustrates a replacement process 1600 (e.g., method, etc.) for replacing the mounting bracket assembly 700. The replacement process 1600 may be performed by a service technician (e.g., a mechanic, line worker, robot, automated machine, etc.).

The replacement process 1600 begins in block 1604 with uncoupling, by a service technician, the security tab 313 from the security tab recess 208. The service technician unscrews the security screw from the security tab 313. In other embodiments, if the security tab 313 is coupled to the mounting frame 100 in another manner than the security screw, the service technician will need to take appropriate actions to separate the mounting frame 100 from the security tab 313.

The replacement process 1600 continues in block 1608 with uncoupling, by a service technician, the faceplate 300 from the mounting frame 100. The service technician will slide the faceplate 300 off the mounting frame 100. In some embodiments, the service technician then replaces the faceplate 300 with an alternative version of the faceplate 300 (i.e., replacing the flat faceplate 302 with the sloped faceplate 500).

The replacement process 1600 continues in block 1612 with removing, by a service technician, the device 800 and the screen 806 from the faceplate 300. The service technician unscrews the screws from the display screen mounting holes 334 to remove the screen 806 from the faceplate 300. The service technician then disconnects all wiring from the device 800 (i.e., power supply, ethernet cable, etc.) so that the device 800 can be safely removed.

The replacement process 1600 continues in block 1616 with unmounting, by a service technician, the mounting frame 100 from the wall. The service technician unscrews the mounting frame 100 from the wall by removing the screws from the mounting channels 130. In other embodiments, if the mounting frame 100 is coupled to the wall in another manner, the service technician will need to take appropriate actions to separate the mounting frame 100 from the wall.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable, or releasable). Such joining may be achieved with the two components, or the two components and any additional intermediate components being integrally formed as a single monolithically body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

What is claimed is:

1. A mounting bracket assembly comprising:
a mounting frame comprising:
a mounting frame first side,
a mounting frame second side contiguous with the mounting frame first side,
a mounting frame third side contiguous with the mounting frame second side,
a mounting frame fourth side contiguous with the mounting frame third side and the mounting frame first side,
a face surface extending along the mounting frame second side and the mounting frame fourth side,
a plurality of mounting channels extending along the mounting frame comprising a first mounting channel, a second mounting channel, a third mounting channel, and a fourth mounting channel, and
a first receiving channel located on the face surface, the first receiving channel extending along a first axis, and a second receiving channel located on the face surface, the second receiving channel extending along a second axis parallel the first axis; and
a faceplate comprising:
a faceplate base,
a first guide channel extending along the first axis, the first guide channel configured to be coupled to the first receiving channel, and
a second guide channel extending along the second axis, the second guide channel configured to be coupled to the second receiving channel.

2. The mounting bracket assembly in claim 1, further comprising:
a plurality of knockout holes located on the mounting frame third side.

3. The mounting bracket assembly in claim 1, wherein said faceplate further comprises:
a faceplate ledge extending from a first side of the faceplate base away from the faceplate base; and
a security tab extending from the faceplate ledge away from the faceplate base.

4. The mounting bracket assembly in claim 3, wherein said mounting frame further comprises:
an alignment groove extending along the mounting frame first side, the alignment groove located between the first mounting channel and the second mounting channel;
a security tab recess located on an outer side of the mounting frame first side opposite a portion of the alignment groove, the security tab recess configured to couple to the security tab.

5. The mounting bracket assembly in claim 3, wherein the security tab is located equidistance between the first guide channel and the second guide channel.

6. The mounting bracket assembly in claim 1, wherein said faceplate further comprises:
a security tab extending away from the faceplate base in the same direction as the first guide channel and the second guide channel, the security tab configured to be coupled to an outer side of the mounting frame first side.

7. The mounting bracket assembly in claim 1, wherein said faceplate further comprises:
an end faceplate contiguous with the faceplate base; and
a side faceplate contiguous with the faceplate base and the end faceplate;
wherein the faceplate base is sloped at an angle relative to the end faceplate.

8. The mounting bracket assembly in claim 1, wherein said mounting frame is disposed along a first plane and further comprises:
a wall surface disposed along a second plane;
a first cut-out located on the wall surface of the mounting frame second side; and
a second cut-out located on the wall surface of the mounting frame fourth side.

9. The mounting bracket assembly in claim 1, wherein said mounting frame is disposed along a first plane and further comprises:
an alignment groove extending along the mounting frame first side, the alignment groove located between the first mounting channel and the second mounting channel;
wherein the alignment groove is centered on an alignment axis that is parallel to the first plane, a reference line intersects and is orthogonal to the first plane, and the reference line extends through both the alignment axis and a center of gravity of the mounting frame.

10. The mounting bracket assembly in claim 1, wherein the first guide channel further comprises:
a first guide channel first portion;
a first guide channel second portion; and
a slot that is continuous with at least one of the first guide channel first portion and the first guide channel second portion.

11. The mounting bracket assembly in claim 1, wherein the second guide channel further comprises:
a second guide channel first portion;
a second guide channel second portion; and
a slot that is continuous with at least one of the second guide channel first portion and the second guide channel second portion.

12. The mounting bracket assembly in claim 1, wherein the first receiving channel further comprises:
a first receiving channel first portion;
a first receiving channel second portion; and
a slot that is continuous with at least one of the first receiving channel first portion and the first receiving channel second portion.

13. The mounting bracket assembly in claim 1, wherein the second receiving channel further comprises:
a second receiving channel first portion;
a second receiving channel second portion; and
a slot that is continuous with at least one of the second receiving channel first portion and the second receiving channel second portion.

14. A mounting bracket assembly comprising:
a mounting frame comprising:
a mounting frame first side,
a mounting frame second side contiguous with the mounting frame first side,
a mounting frame third side contiguous with the mounting frame second side,
a mounting frame fourth side contiguous with the mounting frame third side and the mounting frame first side,
a plurality of mounting channels extending along the mounting frame comprising:
a first mounting channel, a second mounting channel, a third mounting channel, and a fourth mounting channel;
an alignment groove extending along the mounting frame first side, the alignment groove located between the first mounting channel and the second mounting channel,
a first receiving channel located on the mounting frame second side extending along a first axis, and a second receiving channel located on the mounting frame fourth side extending along a second axis parallel the first axis,
a first cut-out located on the mounting frame second side, and
a second cut-out located on the mounting frame fourth side; and
a faceplate removably coupled to the mounting frame comprising:
a faceplate base,
a first guide channel extending along the first axis, the first guide channel configured to be coupled to the first receiving channel,
a second guide channel extending along the second axis, the second guide channel configured to be coupled to the second receiving channel, and
a security tab extending away from the faceplate base in the same direction as the first guide channel and the second guide channel, the security tab configured to be coupled to an outer side of the mounting frame first side.

15. The mounting bracket assembly in claim 14, wherein said faceplate further comprises:
an end faceplate contiguous with the faceplate base; and
a side faceplate contiguous with the faceplate base and the end faceplate;
wherein the faceplate base is sloped at an angle relative to the end faceplate.

16. The mounting bracket assembly in claim 14, wherein the first guide channel further comprises:
a first guide channel first portion;
a first guide channel second portion; and
a slot that is continuous with at least one of the first guide channel first portion and the first guide channel second portion.

17. A mounting bracket assembly comprising:
a mounting frame comprising:
a mounting frame first side,
a mounting frame second side contiguous with the mounting frame first side,
a mounting frame third side contiguous with the mounting frame second side,
a mounting frame fourth side contiguous with the mounting frame third side and the mounting frame first side,
a plurality of mounting channels extending along the mounting frame comprising:
a first mounting channel, a second mounting channel, a third mounting channel, and a fourth mounting channel;
an alignment groove extending along the mounting frame first side, the alignment groove located between the first mounting channel and the second mounting channel,
a first receiving channel located on the mounting frame second side extending along a first axis and a second receiving channel located on the mounting frame fourth side extending along a second axis parallel the first axis, and
a plurality of knockout holes located on the mounting frame third side, the plurality of knockout holes located on either side of the alignment groove; and
a faceplate comprising:
a faceplate base,
a first guide channel extending along the first axis, the first guide channel configured to be coupled to the first receiving channel, and
a second guide channel extending along the second axis, the second guide channel configured to be coupled to the second receiving channel.

18. The mounting bracket assembly in claim 17, wherein said faceplate further comprises:
an end faceplate coupled to the faceplate base; and
a side faceplate coupled to the faceplate base, the side faceplate further coupled to the end faceplate;
wherein the faceplate base is sloped at an angle relative to the end faceplate.

19. The mounting bracket assembly in claim 18, wherein the first guide channel further comprises:
a first guide channel first portion;
a first guide channel second portion; and
a slot that is continuous with at least one of the first guide channel first portion and the first guide channel second portion.

20. The mounting bracket assembly in claim 18, wherein said faceplate further comprises:
a faceplate ledge extending from a first side of the faceplate base away from the faceplate base; and
a security tab extending from the faceplate ledge away from the faceplate base;
wherein the security tab is located equidistance between the first guide channel and the second guide channel and configured to be coupled to an outer side of the mounting frame first side.
